(19) United States
(12) Patent Application Publication
(10) Pub. No.: US 2002/0199132 A1
(43) Pub. Date: Dec. 26, 2002

(54) Systems and methods for a knowledge-based power assembly system component diagnostic tool

(76) Inventors: Joseph N. Lachimia, Greensburg, PA (US); George McCracken, Trafford, PA (US)

Correspondence Address: Woodcock Washburn Kurtz, Mackiewicz & Norris LLP, 46th Floor, One Liberty Place, Philadelphia, PA, 19103, US

(21) Appl. No.: 09/887,971

(22) Filed: Jun. 22, 2001

(51) Int. Cl. G06F 11/00

(52) U.S. Cl. 714/14

(57) ABSTRACT

Systems and methods for providing an “Expert” diagnostic tool for circuit breakers are disclosed. The present invention provides information management, repair and service instructions, diagnostics, troubleshooting and training. The present invention also simplifies and streamlines replacement and spare parts research as well as providing a simplified ordering mechanism.

### FIELD OF THE INVENTION

The invention relates generally to the field of diagnosing problems with power system assembly components. More particularly, the invention provides a technique for providing computerized expert assistance to perform maintenance on, diagnose problems with, repair, and if necessary, purchase replacement parts for electrical power system components, particularly high voltage circuit breakers.

### BACKGROUND OF THE INVENTION

There are more than 50,000 vintage in-service, out-of-production circuit breakers of different origins of manufacture. Customers typically plan to keep these breakers in service for many years. The current circuit breaker Experts (employees of various companies) are likely to retire within a two to three year timeframe. The Experts cumulatively have over 130 years of product and diagnostic experience. This level of knowledge and experience cannot readily be replaced.

Utility companies have considerable difficulty maintaining their own internal circuit breaker service capabilities. For example, documentation concerning the circuit breakers may be lost or unavailable. Experienced service personnel retire and utilities find it difficult to train and retain replacement engineers for circuit breaker service. To overcome these drawbacks, a technique to capture and use the knowledge of the current Experts is needed.

### SUMMARY OF THE INVENTION

The present invention is directed to systems and methods for providing an “expert” diagnostic tool for circuit breakers. The present invention provides information management, repair and service instructions, diagnostics, troubleshooting and training in a MICROSOFT WINDOWS help-based format. The present invention also simplifies and streamlines replacement and spare parts order number research as well as providing a simplified, embedded ordering mechanism.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a flow diagram of a typical troubleshooting session as is well-known in the art;

FIG. 2 is a flow diagram of an exemplary diagnostic tool in accordance with the present invention;

FIG. 3 is a portion of an exemplary user interface in accordance with an aspect of the present invention;

FIG. 4a is a portion of an exemplary user interface in accordance with an aspect of the present invention;

FIG. 4b is a further portion of the exemplary user interface of FIG. 4a;

FIG. 4c is a further portion of the exemplary user interface of FIG. 4a;

FIG. 5a-b is a portion of an exemplary kit description in accordance with an aspect of the portion of the user interface of FIG. 4b;

FIG. 6a is an exemplary part number and kit identification diagram in accordance with an aspect of the user interface of FIG. 4b;

FIG. 6b is an exemplary order form in accordance with an aspect of the user interface of FIG. 4b;

FIG. 7 is an exemplary drawing in accordance with an aspect of the user interface of FIG. 4c; and

FIG. 8 is an exemplary checklist in accordance with an aspect of the user interface of FIG. 4c; and

FIG. 9 is an exemplary labeled photograph in accordance with an aspect of the user interface of FIG. 4b.

### DETAILED DESCRIPTION OF THE INVENTION

Overview

Typically, when a circuit breaker user has performance or maintenance issues with equipment, the user will call a human “Expert” for help in diagnosing and correcting the problem. The Expert walks the user through a series of actions in an interactive person-to-person help session. Some time may elapse and some considerable effort may be expended before the user and the human Expert establish a communicative rapport such that the problem or condition of concern is identified. Once the Expert identifies the root cause or probable root cause of the problem or condition, the Expert may then suggest and guide the user through a series of actions to resolve the circuit breaker problem. The Expert is limited by his or her personal knowledge and experience.

Sometimes, the repair will involve the purchase of parts. In that case, the Expert may be involved in identifying the part or parts required for the repair. Identification of the part may require considerable research. Further research may be required to determine the part number of the component needed and still more research to find a supplier for the part. Different suppliers may have different part numbers for the same component. Finally, the user may contact the supplier and purchase the part or parts. Typically installation of the part will require a further conversation with the Expert. If the same Expert is not available, or if some time has elapsed from the time of the first call, the user and human Expert may have to retrace the steps taken so far before beginning a walk-through of the installation process. As can be readily appreciated, such a process is time-consuming and fraught with human error.

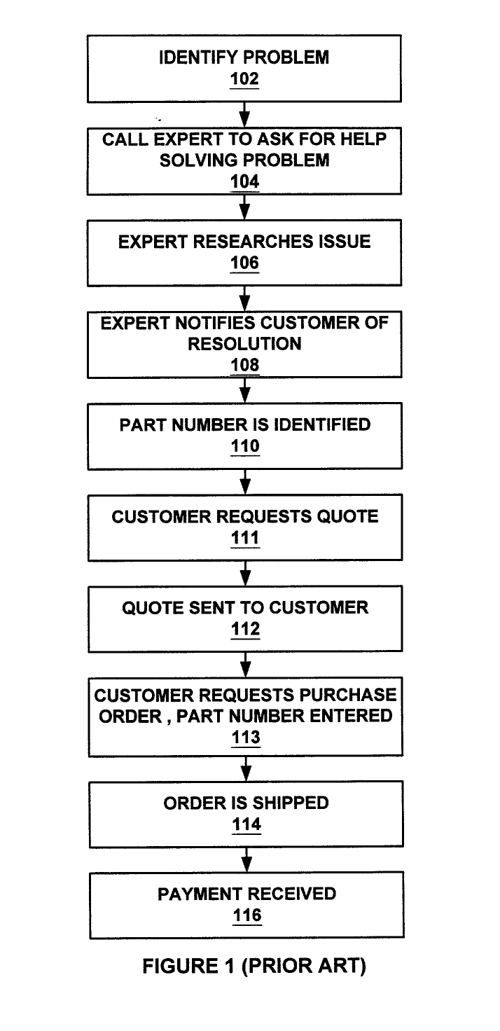

FIG. 1 is a flow diagram of a typical help session as is well-known in the art. At step 102, a problem or maintenance issue with a circuit breaker is identified. At step 104, the user calls the human Expert to ask for help to resolve the problem. At step 106, the human Expert researches the problem or maintenance issue. At step 108, the human Expert notifies the user of the potential solution to the problem or maintenance issue. At step 110 if a part is required, the number of the part is determined. Determining the number of the part required may require researching records stored on microfish or microfilm. Drawings of the part may not be available because the drawings are no longer available. Documentation concerning the shop order/serial number of the breaker may not be able to be found. At step 111, if a part is needed to resolve the problem, the user may ask for a quote. At step 112 a quote may be sent to the customer, and at step 113 a purchase order is received and the number of the part is entered on the purchase order. Step 113 typically requires a separate telephone call to a parts supplier or manufacturer. At step 114, the order is shipped. At step 116, payment may be received by the Expert or his employer for his services, and by the manufacturer, distributor or other source of the ordered part.

Knowledge-Based Diagnostic Tool

This invention utilizes a computer-implemented knowledge base to enable a user, who is not necessarily an “Expert,” diagnose and troubleshoot a circuit breaker problem using an interactive software tool. A user having a circuit breaker problem or maintenance issue can access the diagnostic tool, and follow the step-by-step procedures to diagnose and attempt to resolve the problem. No contact by the user with a human is required. If a part is necessary to resolve the problem, the part is identified and can be ordered from within the diagnostic tool.

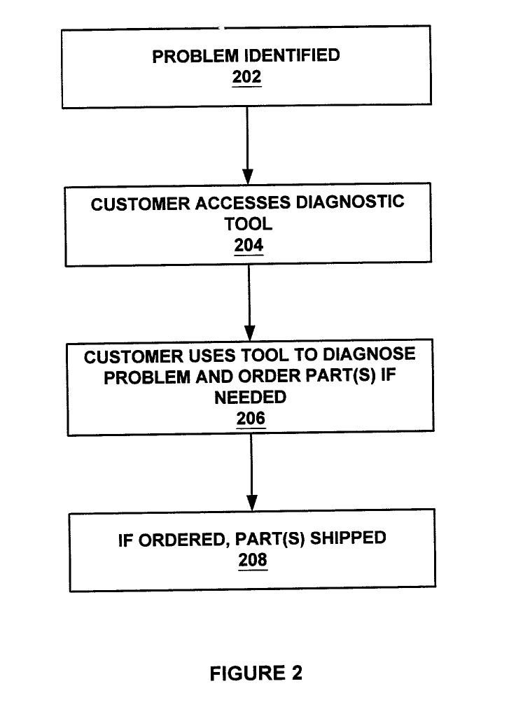

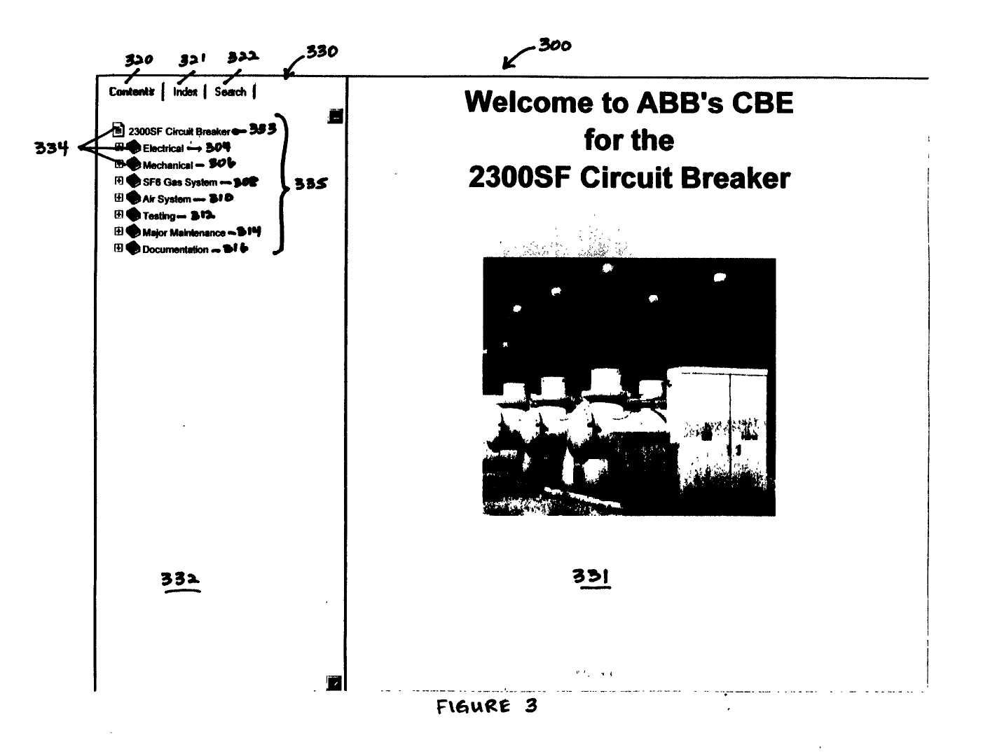

FIG. 2 is a flow diagram illustrating an embodiment of a method of the present invention. At step 202, the user identifies a problem or maintenance issue with the circuit breaker or other power system assembly component. At step 204 the user accesses the diagnostic tool. At step 206 the user uses the diagnostic tool to diagnose the problem and resolve it. If parts are necessary to resolve the problem, a part or parts can be ordered from within the diagnostic tool. At step 208 the parts are shipped.

As can be appreciated, the method of the present invention provides a much simpler way to service power system assembly components or to diagnose and/or correct problems with power system assembly components. The method of the present invention does not require a user to have contact with a human Expert. Additionally, the present invention, unlike a human Expert, may be accessible to the user 24 hours a day, seven days a week. Furthermore, the present invention is provided in a MICROSOFT WINDOWS help-based format week which may make the tool easier to use because many users are familiar with MICROSOFT WINDOWS Help.

For example, assume that a user determines that his 2300SF circuit breaker will not move to the closed position. The user may then access the diagnostic tool, such as by accessing the proper website on a computer network such as the Internet.

After navigating to the proper website and logging in or otherwise establishing contact with the diagnostic tool, and selecting from a list of areas of information, a topic of interest, a user interface such as the one illustrated in FIG. 3 may be displayed. Preferably, information is displayed in a MICROSOFT WINDOWS “help” format, consisting of a toolbar 330 containing options, content pane 331 and navigation pane 332. A specific unit of information (a “topic” 333) is displayed in response to a user's selection. Visual metaphors or icons 334 are provided for navigating through and displaying information. The information is organized into an electronic documentation set. Each topic may employ a combination of text, graphics, hyperlinks, video clips, audio and the like. Headlines, sublines and emphasis, numbered lists, bulleted lists, indented text, tables and the like may be displayed.

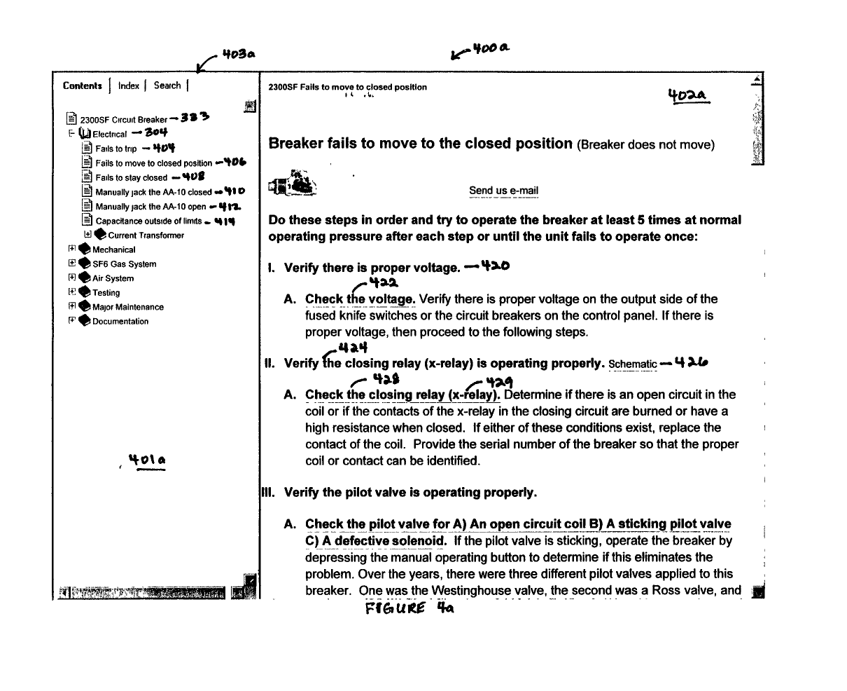

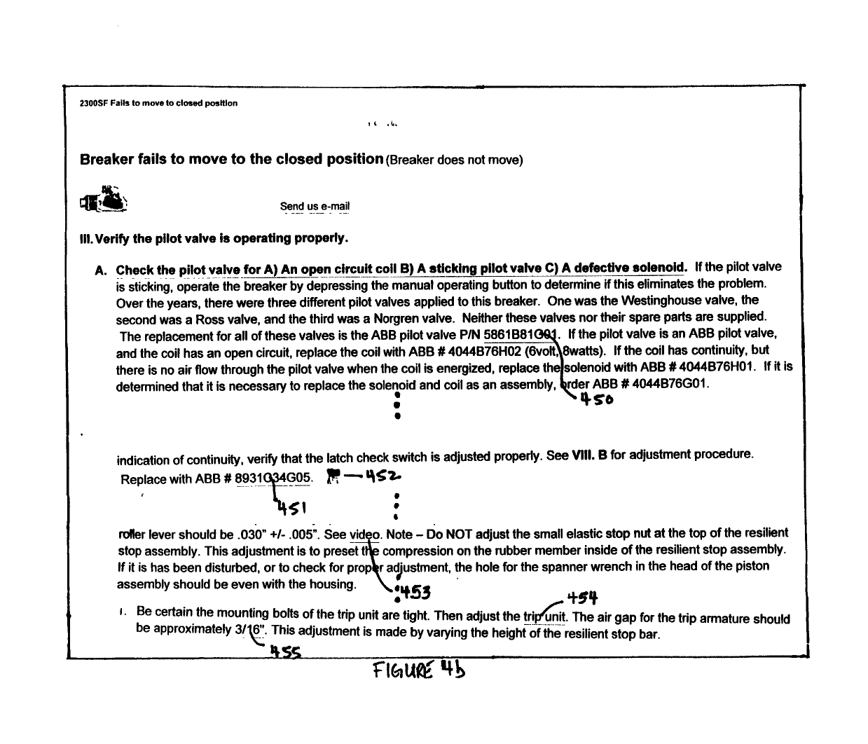

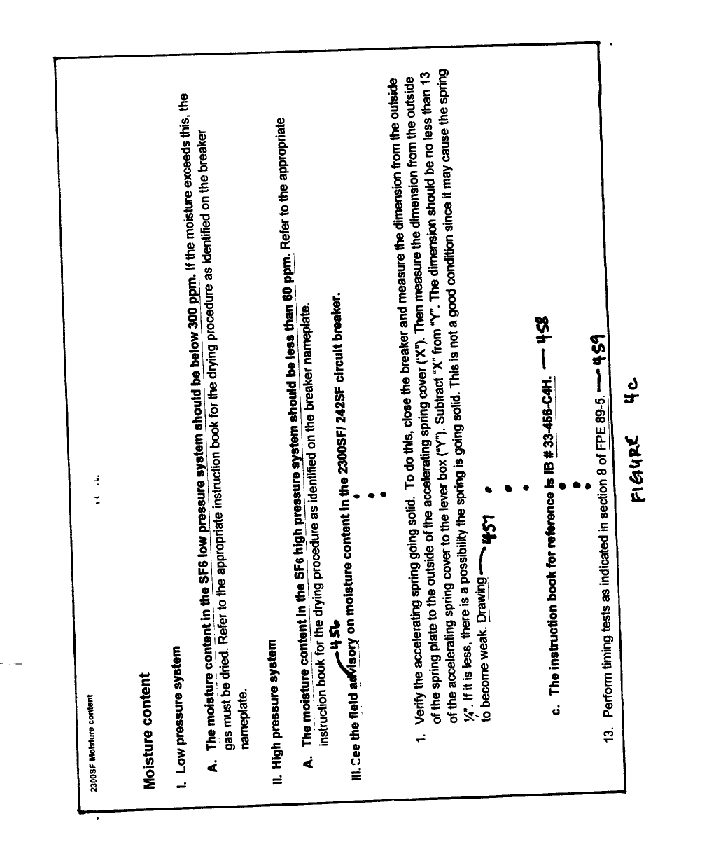

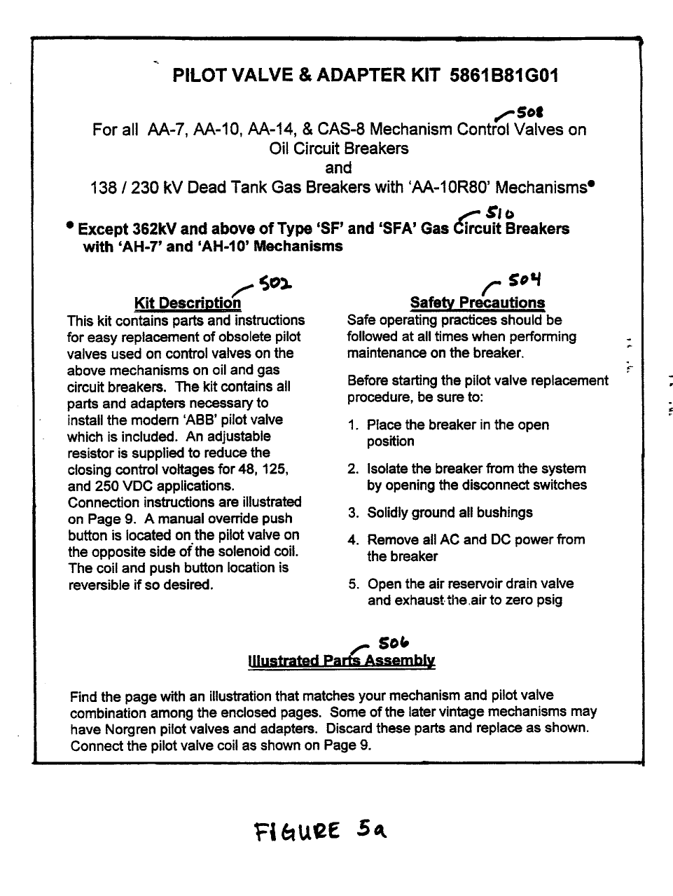

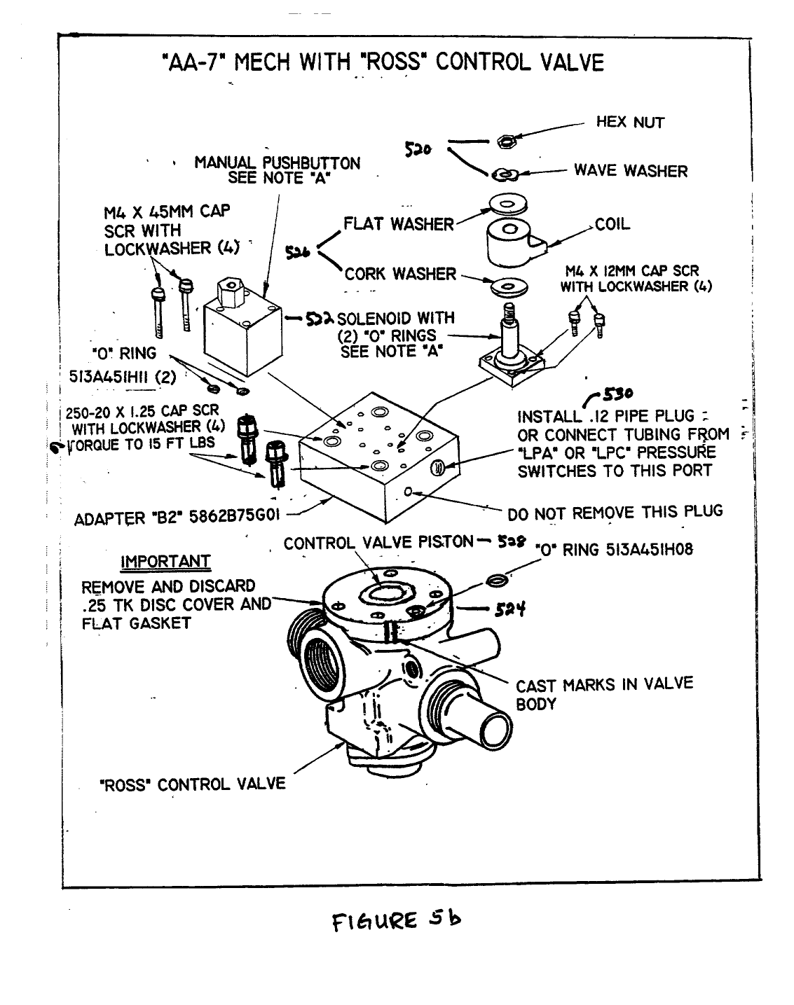

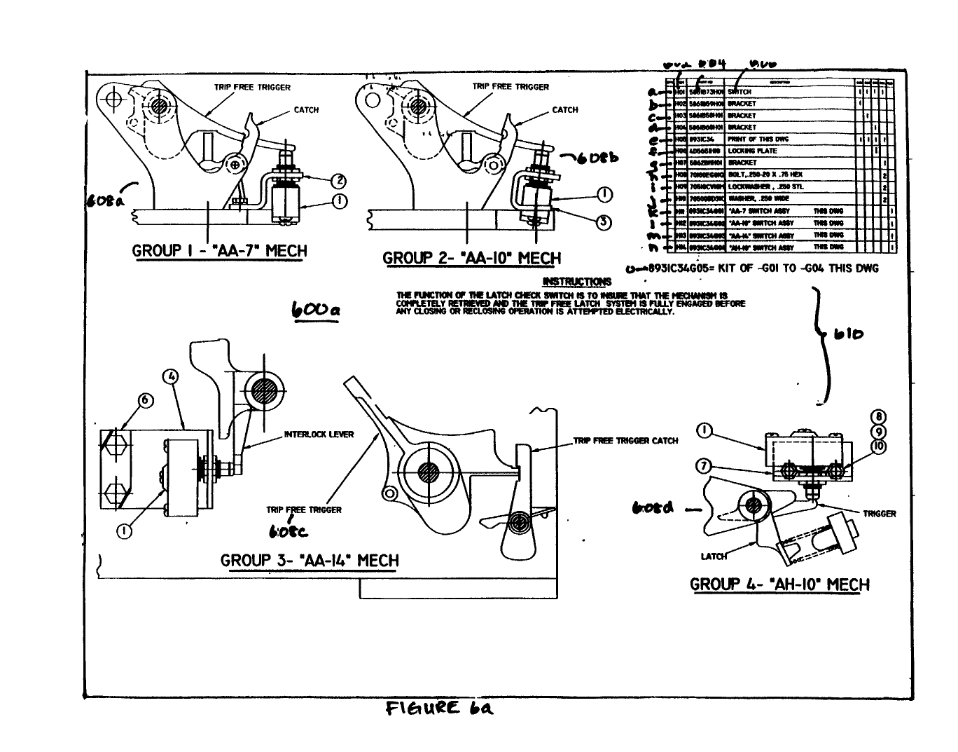

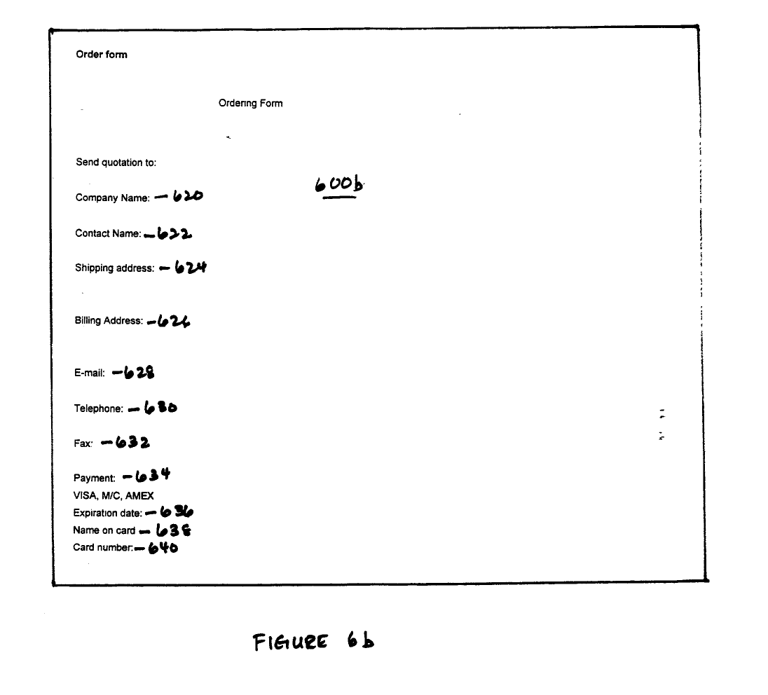

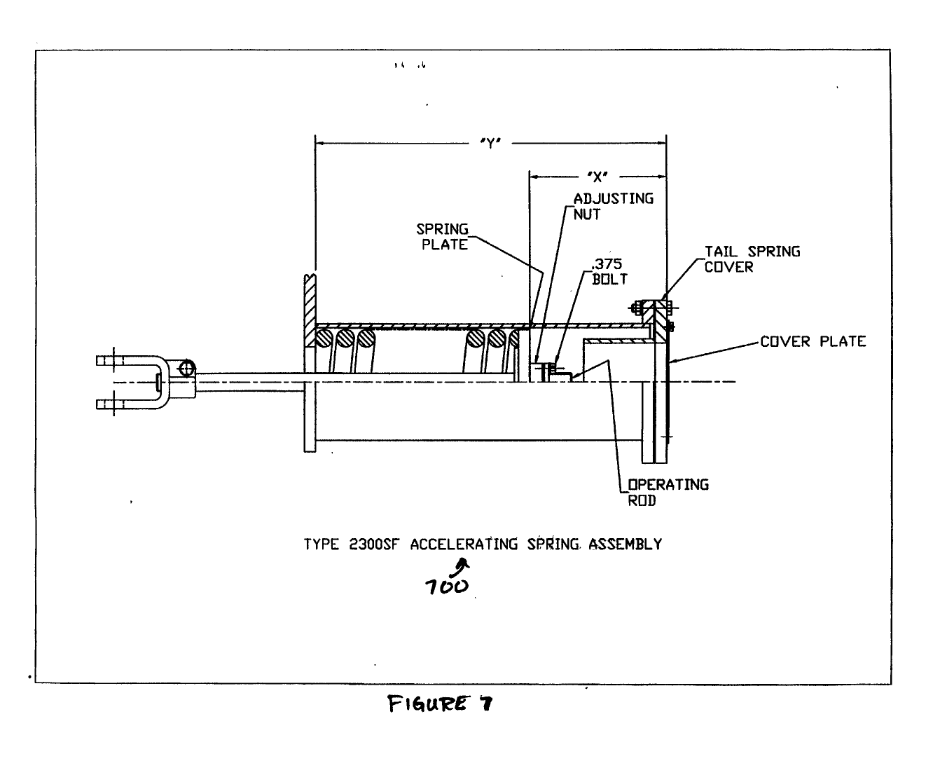

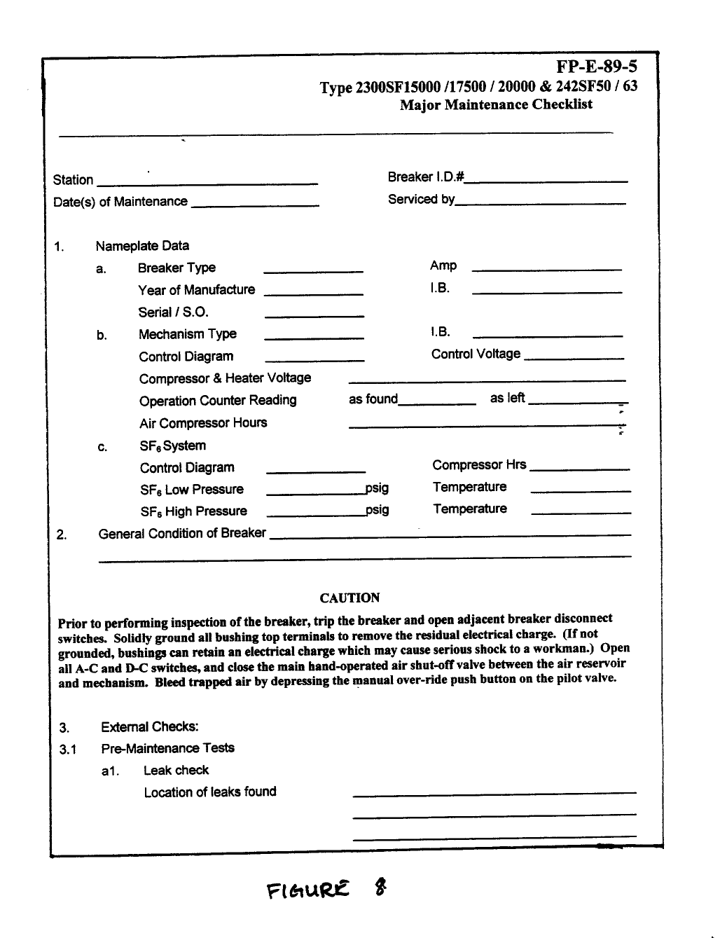

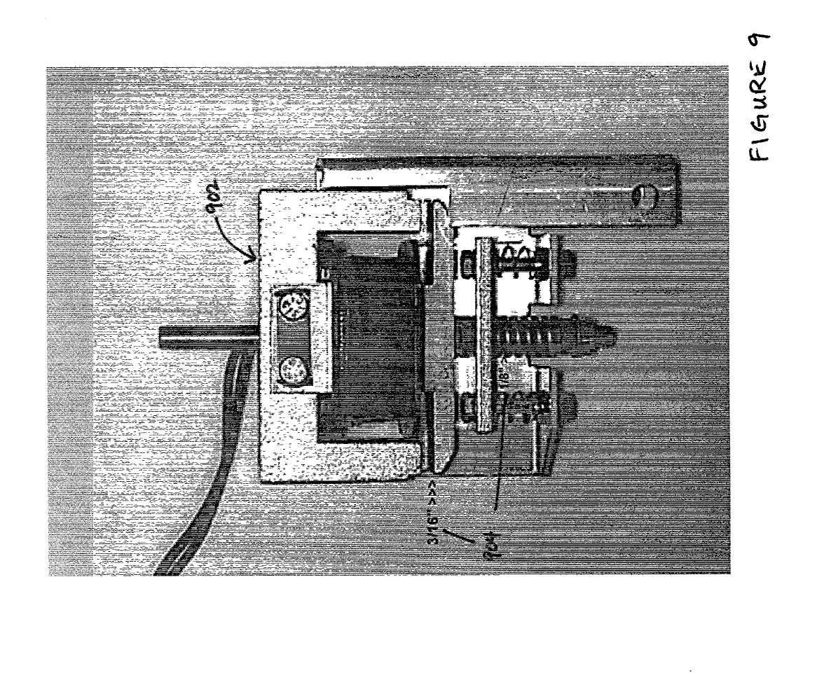

Toolbar 330 may contain the following options: table of contents 320, index 321 and search 322. Clicking on table of contents option 320 may result in the display of exemplary table of contents 335. Table of contents 335 preferably is a tree outline capable of displaying information in an expandable or collapsible hierarchy made up of sub-units such as topics, books and chapters. Topics are categories of information such as information concerning the 2300SF Circuit Breaker. Books represent a sub-topic such as Electrical 304, Mechanical 306, SF6 Gas System 308, Air System 310, Testing 312, Major Maintenance 314, Documentation 316 and the like. Selection of the Book “Electrical” 304 may result in the display of more sub-categories of information (chapters) such as is displayed in FIG. 4a 404, 406, 408, 410, 412, and 414. Chapters contain pages of information in the form of text, graphics and the like.

Table of contents 335 is organized logically with descriptive topic, book and chapter titles so that users looking for information on a particular subject can find the information easily by expanding the table of contents and selecting from the appropriate books and chapters displayed.

Toolbar 330 may also contain an index option 321. An index is used to locate information within the tool. The index contains keywords logically associated with relevant topics may guide a user to the information the user is looking for. The index preferably is in alphabetical order.

Toolbar 330 may also contain a search option 322. Clicking on search option 322 enables a user to type in a word or words to search for. A full-text search database associated with the search option 322 catalogs every word in the diagnostic tool. By way of comparison, the index option typically contains only keywords.

FIG. 3 represents an exemplary user interface 300, that may be displayed after a user selects a topic such as a 2300SF Circuit Breaker, 333. It can be seen that the following books are displayed under 2300SF Circuit Breaker 302: Electrical 304, Mechanical 306, SF6 Gas System 308, Air System 310,

Testing 312, Major Maintenance 314 and Documentation 316. It should be noted that the categories listed are exemplary in nature and other suitable categories may be listed without departing from the scope of the present invention.

FIG. 4a illustrates an aspect of an exemplary user interface that may be displayed in response to a user's selection, (e.g. the user selects the book “Electrical” 304). The present invention captures substantially all of the major problems in circuit breaker operational performance and the user may select the choice that represents his or her interest. The exemplary interface 400a includes a navigation pane or frame, 401a (which contains a listing of possible categories from which the user can select, content pane or frame 402a which contains instructions corresponding to the category the user selected and toolbar 403a which may contain contents, index, and search options.

The instructions in content pane 402a preferably are primarily textual in nature but contain within them hyperlinks, typically underlined and displayed in blue, that a user may click on to receive additional information on the topic. The additional information displayed as a result of clicking on the hyperlink contains information including but not limited to: additional text, black- and white and/or color photographs, labeled black-and-white and/or color photographs, videoclips, field advisory information, instruction manuals, schematics, drawings, lists of available parts or kits, and other suitable items.

In the exemplary interface 400a provided, the user has selected chapter “Fails to move to closed position” 406 for topic 2300SF Circuit Breaker, 333 under the “Electrical” book, 304. In the exemplary user interface 400a, the chapters in frame 401a are “Fails to trip” 404, “Fails to move to closed position” 406, “Fails to stay closed” 408, “Manually jack the AA-10 closed” 410, “Manually jack the AA-10 open” 412 and “Capacitance outside of limits” 414. It should be understood that the particular chapters listed are exemplary chapters only, and other suitable chapters are contemplated by the present invention.

In accordance with another aspect of the present invention, navigation through the diagnostic tool is strategically organized so that the solution path is similar to the way an ideal human Expert would diagnose and resolve the problem or maintenance issue. Preferably, the present invention lists chapters 404, 406, 408, 410, 412 and 414 in the order of easier and more common problems to more complicated and less common problems.

For example, in content pane 402a, instructions are provided for the user to follow, assuming the user has selected “Fails to move to closed position” 406. Instruction heading 420 of the example says, “I. Verify there is proper voltage.” Heading 420 is followed by more detailed instructions 422: “A. Check the voltage. Verify there is proper voltage on the output side of the fused knife switches or the circuit breakers on the control panel. If there is proper voltage, then proceed to the following steps.” The user may find that after following these instructions the breaker still does not move. The user may then proceed to instruction heading 424: “II. Verify the closing relay (x-relay) is operating properly”.

Instruction heading 424 in exemplary user interface 400a is followed by hypertext link 426 “Schematic”. Hypertext links preferably are underlined and are displayed in blue print, although other link indicators such as the use of italic print and/or other colors are contemplated by the invention. Hyperlinks such as link 426 are provided so that upon selection by the user by “clicking” on the link, additional information will be displayed to the user in a frame or screen. The additional information may include additional text, photographs, labeled photographs, videoclips, field advisory information, instruction manuals, schematics, drawings, lists of available parts or kits, and other suitable items.

Links to the pictures, drawings, etc are placed in appropriate locations in the text. Trouble-shooting instructions and potential solutions and responses are accompanied with references to replacement assemblies, subassemblies and individual parts that may be used to potentially solve the circuit breaker problem or maintenance issue in question.

Selection of hyperlink 426 “Schematic” by clicking on the link, will result in the display of a schematic in a frame or screen. A schematic may include a graphical representation of a circuit, using lines to represent wires and various symbols to represent components. The schematic may also include a legend describing what the symbols represent, a text description, charts and the like. The schematic may also include highlighted areas, which may isolate the particular location of a component or components of special interest or otherwise clarify instructions or other text contained in content pane 402a.

Instruction heading 424 and hyperlink 426 are followed in exemplary user interface 400a content pane 402a by more detailed instructions 428: “A. Check the closing relay (x-relay). Determine if there is an open circuit in the coil or if the contacts of the x-relay in the closing circuit are burned or have a high resistance when closed. If either of these conditions exist, replace the contact of the coil. Provide the serial number of the breaker so that the proper coil or contact can be identified.”

“x-relay” 429 contained within detailed instructions 428 in exemplary interface 400a content pane 402a is a hyperlink, preferably indicated by underlining and the blue color of the font of the link. Upon selection of the “x-relay” link 429, a frame including a photograph may be displayed. The photograph may be labeled and/or may contain notations to clarify instructions or other text contained in content pane 402a.

FIG. 4b illustrates a continuation of content pane 402a. Referring now to FIG. 4b an exemplary replacement part “5861B81G01” link 450 is displayed. Clicking on link 450 results in the display of a replacement parts document, as illustrated by the exemplary replacement parts document depicted in FIG. 5a-b. An exemplary replacement parts document as depicted in FIG. 5a-b may include a kit description 502, safety precautions 504, instructions 506, a list of mechanisms to which the kit is adapted 508, a list of mechanisms to which the kit is not adapted 510, drawings of parts included in the kit 520, 522 and 524, labels 526, 528 descriptions 530 and the like.

Referring again to FIG. 4b, an exemplary replacement parts list link 451 is displayed. Clicking on link 451 results in the display of replacement order reference document 600a as illustrated in FIG. 6a. Exemplary order reference document 600a may contain one or more of the following: item identifier 602a-n, part identification number 604a-o, description 606a-o, FIGS. 608a-d and instructions 610. It can be seen that kit 604o includes Groups 1 through 4, depicted in drawings 608a-d.

According to one aspect of the invention, the ordering process is simplified. Spare parts and spare part kits that may incorporate multiple items in one part number are identified. By identifying the part number of the part or kit within the diagnostic tool, no research has to be done to determine the part or kit number, thereby expediting the quotation and ordering process.

Clicking on link 452 results in the display of an order form such as the one illustrated by the exemplary order form 600b illustrated in FIG. 6b. Preferrably, link 452 is a shopping cart icon. Ordering form 600b may include but is not restricted to including the following information fields: Company name 620, Contact name 622, Shipping Address 624, Billing Address 626, E-mail 628, Telephone 630, Fax 632, Payment 634, Expiration Date 636, Name on Card 638 and Card Number 640.

FIG. 4b illustrates another aspect of an exemplary user interface, wherein the interface contains a link 453 to a video, “video”. Clicking on link 453 will initiate the launching of a video player, such as but not limited to MICROSOFT MEDIA PLAYER and the playing of a videoclip.

FIG. 4b also illustrates link “trip unit” and link 455 “3/16”″. Clicking on link 454 may result in the display of a perspective view of a trip unit. The trip unit may be labeled with the parts of the unit and may contain explanatory, illustrative or identifying text. Clicking on link 455 may result in the display of a labeled photograph as illustrated in FIG. 9. Photograph 902 illustrates an exemplary photograph of a component and label 904 illustrates exemplary explanatory, illustrative or identifying text.

FIG. 4c illustrates an exemplary “field advisory” link 456.

Clicking on link 456 may result in the display of a field advisory. FIG. 4c illustrates an exemplary “Drawing” link 457. Clicking on link 457 result in the display of exemplary drawing 700 as illustrated in FIG. 7.

FIG. 4c illustrates an exemplary instruction book link 458 “#33-456-C4H”. Clicking on link 458 results in the display of the associated instruction manual.

FIG. 4c illustrates an exemplary checklist link 459, “FPE 89-5”. Clicking on link 459 results in the display of a checklist such as the exemplary checklist illustrated in FIG. 8.

Throughout the process of navigation through the diagnostic tool, the user may concurrently be acquiring training and developing or broadening skills through diagnosing and troubleshooting problems.

It is noted that the foregoing examples have been provided merely for the purpose of explanation and are in no way to be construed as limiting of the present invention. While the invention has been described with reference to preferred embodiments, it is understood that the words which have been used herein are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

What is claimed is:

1. A computer-implemented method for diagnosing, correcting, and repairing problems with power system assembly components, the method comprising:
providing a list of power system assembly components;
receiving a selection of a component of interest;
providing a list of potential conditions of the component of interest;
providing, in response to the selection of one of said potential conditions, a step-by-step series of actions to take to address the selected condition.

2. The method of claim 1, wherein said list of potential conditions of the power system assembly component is a hierarchical list in the order of most common to least common.

3. The method of claim 1, wherein said list of potential conditions of the power system assembly component is a hierarchical list in the order of less complex to more complex.

4. The method of claim 1 further comprising providing information concerning a kit to do at least one of repair, service and replace the component.

5. The method of claim 1, wherein the power system components comp rise circuit-breakers.

6. The method of claim 1, further comprising providing at least one of pictures, drawings, figures, instruction manuals, data bulletins, schematics, videoclips, photographs, marked up photographs and field advisory data sheets.

7. The method of claim 1, wherein at least one of said series of actions to take further comprises an action to repair the component.

8. The method of claim 1, wherein at least one of said series of actions to take further comprises an action to service the component.

9. The method of claim 1, wherein at least one of said series of actions to take further comprises an action to replace the component.

10. The method of claim 1, wherein at least one of said series of actions to take further comprises an action to operate the component.

11. The method of claim 4, wherein said kit contains a plurality of components.

12. The method of claim 1, wherein said list of potential conditions are represented as topics.

13. The method of claim 1, wherein said list of potential conditions of the component of interest is represented as books.

14. The method of claim 1, wherein said step-by-step series of actions are displayed as chapters.

15. A method of providing services for diagnosing, repairing, servicing or replacing an electric power system assembly component, the method comprising:
providing a user interface enabling identification of a component of interest;
receiving information concerning the component of interest;
providing a list of possible conditions of the component of interest;
receiving information concerning the condition of interest; and
providing a series of actions associated with the condition of interest.

16. The method of claim 15, further comprising providing at least one of pictures, drawings, figures, instruction manuals, schematics, videoclips, photographs, marked up photographs and field advisory datasheets.

17. The method of claim 15, wherein said services are provided via a computer network.

18. The method of claim 17, wherein the network is the Internet.

19. The method of claim 15, further comprising identifying a part to be replaced.

20. The method of claim 19, further comprising identifying an order number associated with said part to be replaced.

21. The method of claim 19, further comprising identifying a kit number associated with said part to be replaced.

22. A method for diagnosing, correcting, and repairing problems with power system and assembly components, the method comprising:
accessing an on-line diagnostic tool;
interacting with said diagnostic tool by selecting a component of interest;
obtaining a hierarchical list of conditions associated with said component of interest;
selecting a possible condition of interest;
following steps displayed by said diagnostic tool in response to selected condition; and
if required, ordering a replacement part from within said diagnostic tool.

23. A system comprising a server computer, the server comprising:
a database of electric power assembly components to be identified, repaired, serviced or purchased;
an interface that accepts input concerning the component of interest; and
a help engine that:
receives information concerning the component of interest;
receives data concerning actions to take associated with the component of interest; and
displays the data concerning actions to take.

24. The system of claim 23, wherein said help engine is a MICROSOFT WINDOWS-based engine.

25. The system of claim 24, wherein said MICROSOFT WINDOWS-based engine contains icons denoting at least one of a topic, a book and a chapter.

26. A computer-readable medium containing computer-executable instructions for performing the method of claim 1.
